(19) United States
(12) Patent Application Publication
(10) Pub. No.: US 2018/0158604 A1
(43) Pub. Date: Jun. 7, 2018

(54) SYSTEM AND METHOD OF FORMING ADDITIVE MANUFACTURED COMPONENTS USING RADIANT ENERGY

(71) Applicant: General Electric Company, Schenectady, NY (US)

(72) Inventors: Tiffany Muller Craft, Simpsonville, SC (US); Archie Lee Swanner, Jr., Easley, SC (US)

(21) Appl. No.: 15/367,744

(22) Filed: Dec. 2, 2016

(51) Int. Cl. H01F 41/02; B33Y 30/00; B33Y 50/02; B33Y 70/00; B22F 3/00; B33Y 80/00; H01F 7/20; H01F 7/02

(52) U.S. Cl. CPC H01F 41/0253; B33Y 30/00; B33Y 50/02; H01F 7/0273; B22F 3/008; B33Y 80/00; H01F 7/206; B33Y 70/00

(57) ABSTRACT

Additive manufacturing systems are disclosed. The systems may include a build platform, and at least one magnet positioned adjacent the build platform. The magnet(s) may be configured to manipulate a magnetic powder material positioned on the build platform to form a pre-sintered component having a first geometry. The system may also include at least one sprayer nozzle positioned adjacent the build platform, where the at least one sprayer nozzle may be configured to coat the pre-sintered component formed from the magnetic powder material with a binder material. Additionally, the system may include at least one radiant energy component positioned adjacent the build platform. The radiant energy component(s) may be configured to sinter the pre-sintered component to form a sintered component having a second geometry identical to the first geometry of the pre-sintered component.

### CROSS-REFERENCE TO RELATED APPLICATION

This application is related to co-pending U.S. application Ser. No. ______, GE docket numbers 314248-1 and 314870-1, all filed on Dec. 2, 2016.

### BACKGROUND OF THE INVENTION

The disclosure relates generally to additive manufacturing, and more particularly, to additive manufacturing systems and methods of forming additive manufactured components using radiant energy.

Components or parts for various machines and mechanical systems may be built using additive manufacturing systems. Conventional additive manufacturing systems may build such components by continuously layering powder material in predetermined areas and performing a material transformation process on each layer of the powder material until a component is built. The material transformation process may alter the physical state of each layer of the powder material from a granular composition to a solid material. The components built using these conventional additive manufacturing systems and processes have nearly identical physical attributes as conventional components typically made by performing machining processes on stock material.

Conventional additive manufacturing systems and/or conventional additive manufacturing processes typically require a large amount of time to create a final component. For example, each component is built layer-by-layer and each layer of the powder material can have a maximum thickness in order to ensure each layer of powder material undergoes a desirable material transformation when forming the component. As such, the material layering and material transformation process may be formed numerous times during the building of the component. Furthermore, each time a single layering and material transformation process is performed, additional processes must be performed to ensure the component is being built accurately, and/or according to specification. Some of these additional processes include realigning the component and/or the build plate in which the component is being built on, adjusting devices or components used to perform the material transformation process (e.g., lasers), reapplying powder material in portions of the layer being formed that require additional material, and/or removing excess powder material from the layer being formed and/or the portions of the component already built. As a result, building a component using conventional additive manufacturing systems and/or processes can take hours or even days.

### BRIEF DESCRIPTION OF THE INVENTION

A first aspect of the disclosure provides an additive manufacturing system including: a build platform; at least one magnet positioned adjacent the build platform, the at least one magnet configured to manipulate a magnetic powder material positioned on the build platform to form a pre-sintered component having a first geometry; at least one sprayer nozzle positioned adjacent the build platform, the at least one sprayer nozzle configured to coat the pre-sintered component formed from the magnetic powder material with a binder material; and at least one radiant energy component positioned adjacent the build platform, the at least one radiant energy component configured to sinter the pre-sintered component to form a sintered component having a second geometry identical to the first geometry of the pre-sintered component.

A second aspect of the disclosure provides an additive manufacturing system including: a build platform; at least one magnetic coil substantially surrounding the build platform, the at least one magnet coil configured to manipulate a magnetic powder material positioned on the build platform to form a pre-sintered component having a geometry; and at least one sprayer nozzle positioned adjacent the build platform, the at least one sprayer nozzle configured to coat the pre-sintered component formed from the magnetic powder material with a binder material.

A third aspect of the disclosure provides an additive manufacturing system including: a build platform; at least one magnet positioned adjacent the build platform, the at least one magnet configured to: manipulate a magnetic powder material positioned on the build platform to form a pre-sintered component having a first geometry; and sinter the pre-sintered component to form a sintered component having a second geometry identical to the first geometry of the pre-sintered component; and at least one sprayer nozzle positioned adjacent the build platform, the at least one sprayer nozzle configured to coat the pre-sintered component formed from the magnetic powder material with a binder material.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a front view of an additive manufacturing system including a plurality of magnets, a plurality of radiant energy components, and magnetic powder material according to embodiments.

FIG. 2 shows a top view of the additive manufacturing system and the magnetic powder material of FIG. 1, according to embodiments.

FIG. 3 shows a front view of the additive manufacturing system of FIG. 1, and a pre-sintered component formed from the magnetic powder of FIG. 1 material according to embodiments.

FIG. 4 shows a top view of the additive manufacturing system and the pre-sintered component formed from the magnetic powder material of FIG. 3, according to embodiments.

FIG. 5 shows a front view of the additive manufacturing system of FIG. 1, the pre-sintered component formed from the magnetic powder material of FIG. 3 and a binder material according to embodiments.

FIG. 6 shows a front view of the additive manufacturing system of FIG. 1, and the pre-sintered component formed from the magnetic powder material of FIG. 3 covered in the binder material according to embodiments.

FIGS. 7-8 show front views of the additive manufacturing system of FIG. 1 and pre-sintered component formed from the magnetic powder material being sintered by the plurality of radiant energy components and build chamber, respectively, according to embodiments.

FIG. 9 shows a front view of the additive manufacturing system of FIG. 1 and a sintered component formed from the magnetic powder material according to embodiments.

FIG. 10 shows a front view of the additive manufacturing system of FIG. 1 and pre-sintered component formed from the magnetic powder material being sintered, according to further embodiments.

FIGS. 11 and 12 show a front view of an additive manufacturing system including a plurality of magnets manipulating and sintering, respectively, the magnetic powder material, according to further embodiments.

FIGS. 13 and 14 show a front view of an additive manufacturing system including a plurality of magnetic coils and magnetic powder material according to embodiments.

FIG. 15 shows a flow chart of an example process for forming a sintered component, according to embodiments.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within an additive manufacturing system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As indicated above, the disclosure provides additive manufacturing, and more particular, the disclosure provides additive manufacturing system and methods of forming additive manufactured components using radiant energy.

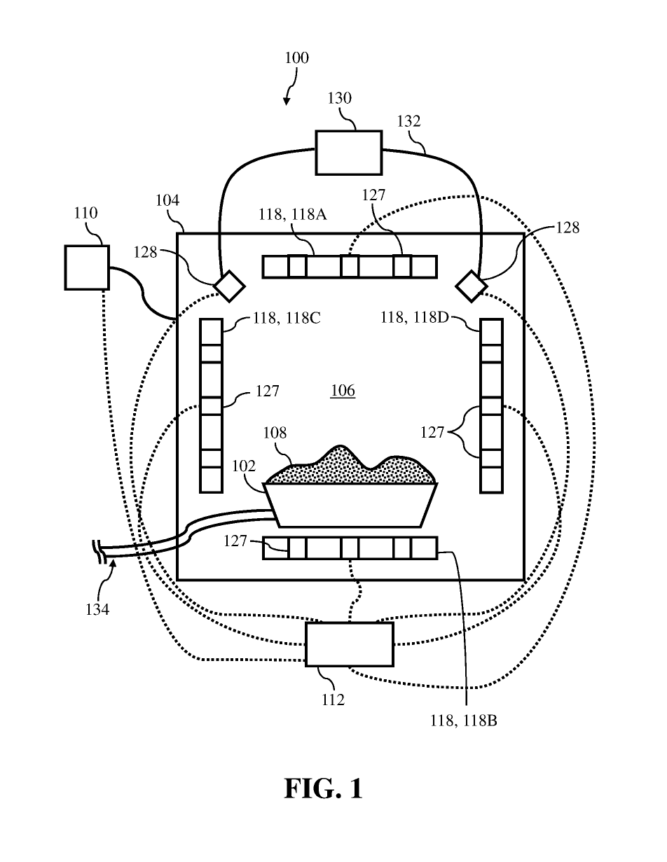

These and other embodiments are discussed below with reference to FIGS. 1-15. However, those skilled in the art will readily appreciate that the detailed description given herein with respect to these Figures is for explanatory purposes only and should not be construed as limiting.

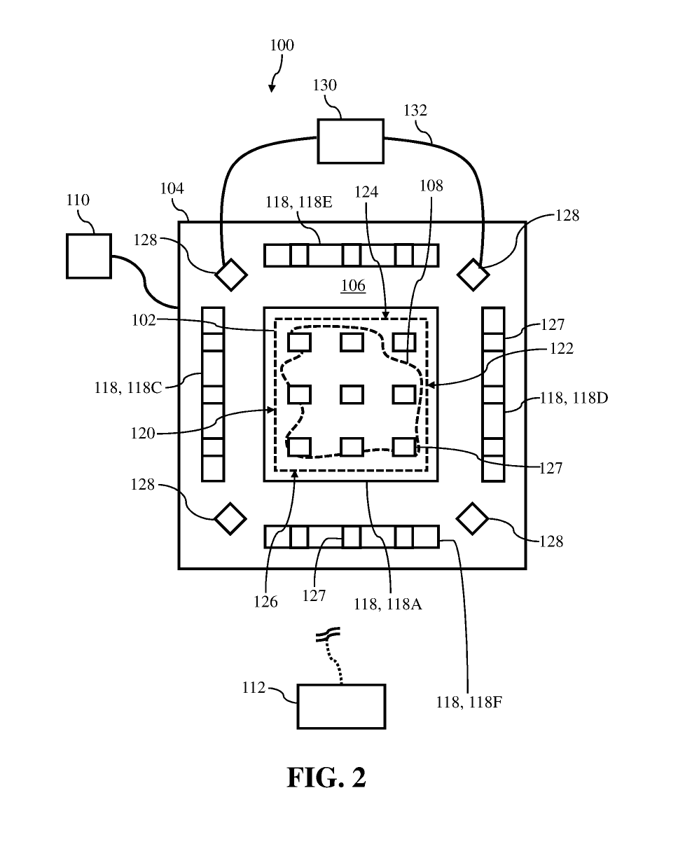

FIGS. 1 and 2 show a front and top view, respectively, of an additive manufacturing system 100. As discussed herein, additive manufacturing system 100 may utilize magnetic waves to initially manipulate powder material to form an entire component and subsequently sinter the entire component using a heat source and/or radiant energy. Additive manufacturing system 100 and the process of forming a sintered component using additive manufacturing system 100, as discussed herein, may significantly reduce a time required to build a component from powder material.

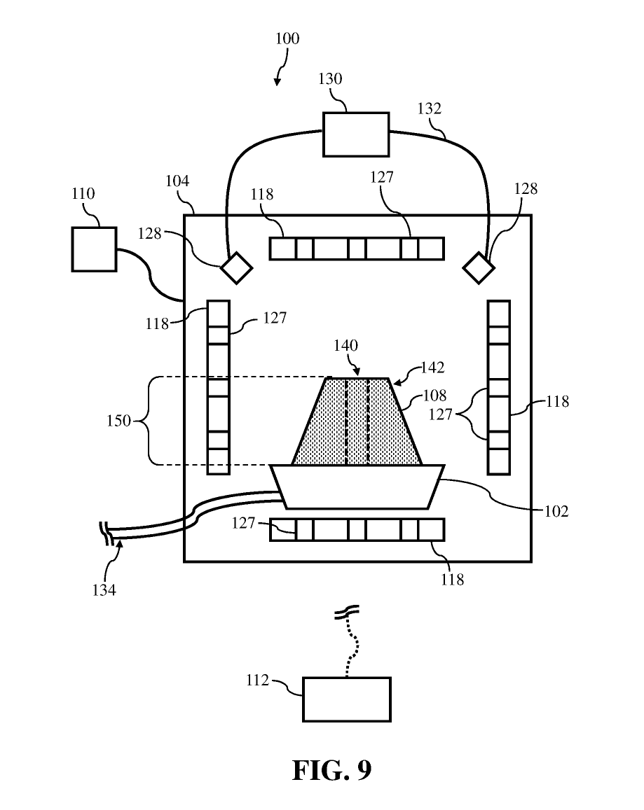

As shown in FIGS. 1 and 2, additive manufacturing system 100 (hereafter, “AMS 100”) may include a build platform 102. Build platform 102 may be positioned within a build chamber 104 of AMS 100. That is, build platform 102 may be positioned or disposed within a chamber or cavity 106 of build chamber 104, such that build chamber 104 may substantially and/or partially surround build platform 102. Build platform 102 may include a build plate (not shown), a build surface and/or build structure for a magnetic powder material 108 that may be utilized by AMS 100 to form a sintered component. As shown in FIGS. 1 and 2 magnetic powder material 108 may be positioned within build chamber 104, and more specifically, may be positioned on build platform 102 of AMS 100. As discussed in detail herein, build platform 102 may receive magnetic powder material 108 and may provide a build structure for the sintered component (see, FIG. 9) formed from magnetic powder material 108 using AMS 100.

Build platform 102 may be formed from any suitable material that may receive and/or support magnetic powder material 108 and the sintered component formed from magnetic powder material 108, as discussed herein. In non-limiting examples, build platform 102 may be formed from non-magnetic, diamagnetic or paramagnetic materials to prevent or significantly reduce any magnetic attraction between build platform 102 and magnetic powder material 108 and/or any other component of AMS 100. In another non-limiting example, build platform 102 may be formed from a magnetic material (e.g., ferromagnetic material) to improve and/or influence a magnetic attraction between build platform 102 and magnetic powder material 108 and/or any other component of AMS 100. Additionally, the size and/or geometry of build platform 102 of AMS 100 may be dependent on, at least in part, the amount of magnetic powder material 108 utilized by AMS 100 to form the sintered component, the size of the sintered component and/or the geometry of the sintered component formed by AMS 100.

Magnetic powder material 108 utilized by AMS 100 may include a variety of powder materials that may include magnetic properties and/or a magnetic moment. Specifically, magnetic powder material 108 may be formed from a magnetic material that may be influenced, displaced, manipulated and/or altered by magnetic waves or energy. In non-limiting examples, magnetic powder material 108 may be formed from ferromagnetic materials including, but not limited to, iron, cobalt, nickel, metal alloys and any other suitable ferrous/magnetic material that is capable of being welded. Additionally, magnetic powder material 108 may be formed from a material that is capable of being sintered when heated. It is understood that “magnetic powder material 108” and “powder material 108” may be used interchangeably, and may refer to any powder material that includes similar material characteristics or properties, and may undergo the processes discussed herein.

As shown in FIGS. 1 and 2, build chamber 104 may at least partially and/or substantially surround build platform 102 and magnetic powder material 108. Specifically in non-limiting examples, build chamber 104 may completely surround and/or encapsulate build platform 102, or alternatively, build chamber 104 may only partially surround build platform 102. Build chamber 104 may be formed as any suitable structure and/or enclosure including build cavity 106 that may receive build platform 102, magnetic powder material 108 and/or additional components of AMS 100 that may be utilized to form a sintered component. In a non-limiting example, and as discussed in detail herein, build chamber 104 may also be heated and/or may provide heat (as a heat source) to cavity 106 including magnetic powder material 108 to aid in the formation of the sintered component from magnetic powder material 108. In the non-limiting example shown in FIGS. 1 and 2, build chamber 104 may be configured as a heat source, and may be coupled to and/or in communication with a heating component 110 that may provide energy (e.g., electricity) to build chamber 104 to heat cavity 106. In another non-limiting example, cavity 106 and/or build chamber 104 may be heated and/or provided heat by placing build chamber 104, including all components of AMS 100 positioned within build chamber 104, into or adjacent a larger heating component.

Build chamber 104 may be formed from any suitable material that may be capable of withstanding high temperature (e.g., 2000° C.) and/or heating to form the sintered component from magnetic powder material 108, as discussed herein. In a non-limiting example, build chamber 104 may be formed from an ultra-high-temperature ceramic material. Similar to build platform 102, build chamber 104 may also be formed from a material having magnetic properties to improve, or alternatively, non-magnetic properties to reduce magnetic attraction between build chamber 104 and magnetic powder material 108. Additionally, the size and/or geometry of build chamber 104 may be dependent on, at least in part, the size and/or the geometry of the sintered component formed by AMS 100.

As shown in FIGS. 1 and 2, a controller 112 of AMS 100 may be in electrical communication with heating component 110 that may be in electrical communication with build chamber 104. Controller 112 may be any suitable electronic device or combination of electronic devices (e.g., computer system, computer program product, processor and the like) that may be in electrical communication with heating component 110 and may be configured to adjust the operation of heating component 110. That is, controller 112 may be in electrical communication with heating component 110 and during a process of forming a sintered component using AMS 100, as discussed herein, controller 112 may be configured to activate and/or engage heating component 110 to provide energy (e.g., electricity) to build chamber 104 to heat cavity 106. Although shown throughout the Figures, it is understood that AMS 100 may or may not utilize heating component 110 to provide energy to build chamber 104. As such, heating component 110 may be included within the Figures for completeness of AMS 100, regardless of whether or not heating component provides energy to heat build chamber 104 when performing the processes discussed herein.

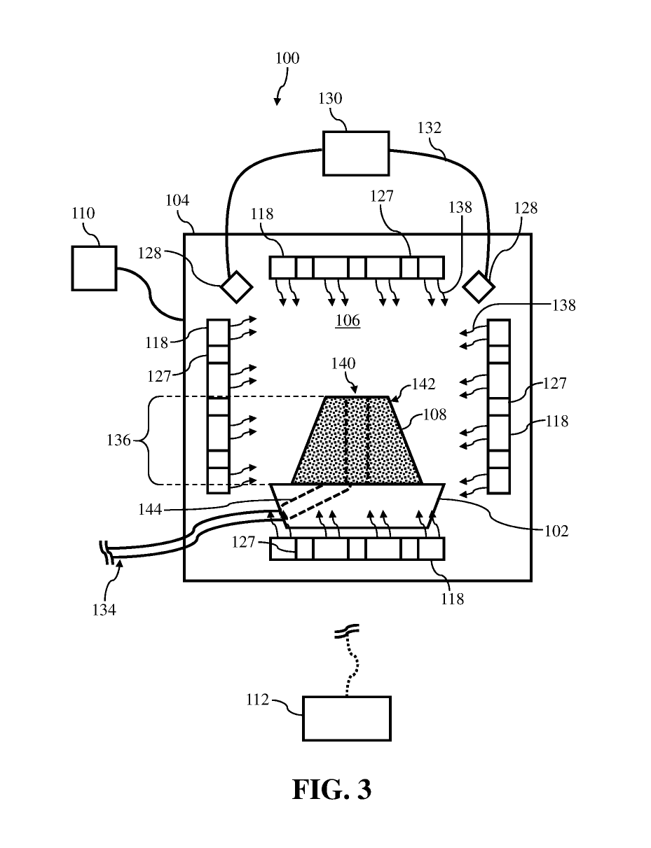

AMS 100 may also include at least one magnet 118 positioned adjacent build platform 102. As shown in the non-limiting example of FIGS. 1 and 2, AMS 100 may include a plurality of magnets 118 that may be positioned adjacent to and/or may substantially surround build platform 102. In other non-limiting examples discussed herein (not shown), AMS 100 may include a single magnet and/or single magnet array positioned adjacent build platform 102. The plurality of magnets 118 may be positioned within build chamber 104, and more specifically, within cavity 106 of build chamber 104. In another non-limiting example, not shown, the plurality of magnets 118 of AMS 100 may be positioned outside of and substantially adjacent to build chamber 104. As shown in FIGS. 1 and 2, the plurality of magnets 118 may also substantially surround build platform 102 and magnetic powder material 108, respectively. As discussed herein, the positioning and/or alignment of each of the plurality of magnets 118 of AMS 100 may aid in the formation of a pre-sintered component (see, FIG. 3) from magnetic powder material 108. That is, and as discussed in detail below, each of the plurality of magnets 118 positioned within build chamber 104 may be configured to produce magnetic waves or fields to manipulate magnetic powder material 108 to form a pre-sintered component within build chamber 104 that may be heated to form a sintered component (see, FIG. 9).

As shown in FIGS. 1 and 2, and discussed herein, the plurality of magnets 118 may substantially surround build platform 102. Specifically, AMS 100 may include a first magnet 118A positioned above build platform 102, and a second magnet 118B (see, FIG. 1) positioned below magnetic powder material 108 positioned on build platform 102. As shown in FIG. 1, second magnet 118B may be positioned opposite and/or may be substantially aligned (e.g., vertically) with first magnet 118A. In the non-limiting example shown, second magnet 118B may be positioned below build platform 102. In another non-limiting example (not shown), second magnet 118B may be positioned, formed integral, and/or formed within build platform 102. Second magnet 118B formed within build platform 102 may be positioned below magnetic powder material 108 disposed on build platform 102 within build chamber 104.

The plurality of magnets 118 of AMS 100 may also include magnets 118C, 118D, 118E (see, FIG. 2), 118F (see, FIG. 2) that are positioned substantial adjacent to, in line with and/or surround build platform 102 and magnetic powder material 108, respectively. With reference to FIG. 2, magnets 118C, 118D, 118E, 118F may be positioned on distinct sides of build platform 102 and magnetic powder material 108, respectively. Specifically, third magnet 118C may be positioned adjacent a first side 120 (see, FIG. 2) of build platform 102, and fourth magnet 118D may be positioned on a second side 122 (see, FIG. 2) of build platform 102, opposite first side 120 and/or third magnet 118C. Additionally, and as shown in FIG. 2, fifth magnet 118E may be positioned adjacent a third side 124 of build platform 102, and sixth magnet 118F may be positioned on a fourth side 126 of build platform 102, opposite third side 124 and/or fifth magnet 118E. Similar to first magnet 118A and second magnet 118B, the respective magnets 118C, 118D, 118E, 118F positioned substantial adjacent to and/or surrounding build platform 102 may be positioned opposite to and/or may be substantially aligned with a corresponding magnet of the plurality of magnets 118. That is, third magnet 118C may be positioned opposite and/or may be substantially aligned (e.g., horizontally and vertically) with fourth magnet 118D, and fifth magnet 118E may be positioned opposite and/or may be substantially aligned (e.g., horizontally and vertically) with sixth magnet 118F.

It is understood that the number of magnets 118 of AMS 100 shown in the figures is merely illustrative. As such, AMS 100 may include more or less magnets 118 than the number depicted and discussed herein. Additionally, the position and/or alignment of the plurality of magnets 118 within build chamber 104 shown in the figures is merely illustrative. The plurality of magnets 118 may be positioned or located in various locations of build chamber 104. Furthermore, the position/location and/or the alignment relation of each magnet 118 may be dependent on, at least in part, the number of magnets 118 included in AMS 10, the size and/or geometry of build chamber 104, and/or the size and/or geometry of the sintered component to be formed using AMS 100.

Each of the plurality of magnets 118 of AMS 100 may include a single magnet (e.g., magnetic polarity shown on first magnet 118A) configured to generate magnetic waves and/or magnetic fields. That is, each of the plurality of magnets 118 of AMS 100 may be formed from a single magnet or magnetized component that is capable of generating a magnetic wave or field. In other non-limiting examples (not shown), each magnet may be formed from a magnet array and/or a plurality of magnets or magnetized components. As shown in FIGS. 1 and 2, controller 112 of AMS 100 may also be in electrical communication with each of the plurality of magnets 118. Controller 112 may be configured to adjust operational characteristics of each of the plurality of magnets 118. That is, and as discussed herein, controller 112 may adjust operational characteristics of each of the plurality of magnets 118, and more specifically, operational characteristics of the magnets or magnetized components forming each of the plurality of magnets 118. The operational characteristics of magnets 118 adjusted by controller 112 may include, but are not limited to, a magnetic polarity for each of the plurality of magnets 118, a magnetic field strength for each of the plurality of magnets 118, an activation (e.g., on or off) of each of the plurality of magnets 118, and/or a distance between the magnets 118 and magnetic powder material 108. As discussed herein, the operational characteristics of the magnetic waves or fields generated by the magnets or magnetized components of each of the plurality of magnets 118, as well as the positioning/alignment of magnets 118, may cause the magnetic waves or fields to interact, collide and/or repel each other to manipulate magnetic powder material 108 to form a pre-sintered component within AMS 100 (see. FIG. 3).

AMS 100 may also include at least one radiant energy component 127 positioned adjacent build platform 102. In a non-limiting example shown in FIGS. 1 and 2, AMS 100 may include a plurality of radiant energy component 127. Similar to the plurality of magnets 118, the plurality of radiant energy components 127 may substantially surround and/or be positioned on or adjacent various sides (see, FIG. 2; first side 120, second side 122 and so on) of build platform 102. As such, and also similar to the plurality of magnets 118, the plurality of radiant energy components 127 may substantially surround and/or be positioned adjacent (e.g., above, below) magnetic powder material 108 positioned on build platform 102. In a non-limiting example, the plurality of radiant energy components 127 may be positioned within build chamber 104 and may be formed integral with, positioned within and/or substantially aligned with the plurality of magnets 118 of AMS 100. Specifically as shown in FIG. 1, the plurality of radiant energy components 127 may be embedded, at least partially surrounded by and/or positioned between the various magnetic components forming each of the plurality of magnets 118 of AMS 100. In another non-limiting example where each of the plurality of magnets 118 are formed as a magnet array (e.g., a plurality of individual magnets), the plurality of radiant energy components 127 may be positioned adjacent to and/or substantially surrounded by the plurality of magnets forming the magnet array. In other non-limiting examples (not shown), the plurality of radiant energy components 127 may be positioned outside of build chamber 104, may be distinct from the plurality of magnets 118 and/or may be positioned adjacent to (e.g., closer to build platform 102) the plurality of magnets 118.

As shown in FIG. 1, controller 112 may be electrically coupled and/or in electronic communication with the plurality of radiant energy components 127 in a similar manner discussed herein with respect to heating component 110 and/or the plurality of magnets 118. That is, controller 112 may be in electrical communication with the plurality of radiant energy components 127 and during a process of forming a sintered component using AMS 100, as discussed herein, controller 112 may be configured to activate and/or engage the plurality of radiant energy components 127. The plurality of radiant energy components 127 may be configured to sinter the pre-sintered component (see, FIG. 3) formed from magnetic powder material 108 to form a sintered component (see, FIG. 9). Specifically, the plurality of radiant energy components 127 may be configured to sinter, heat, generate and/or provide radiant energy waves to the pre-sintered component formed from magnetic powder material 108 to form a sintered component within build chamber 104. As such, the plurality of radiant energy components 127 may be formed from any suitable component, device and/or system that is capable of generating, emitting and/or producing radiant energy and/or radiant energy waves that may sinter magnetic powder material 108. In non-limiting examples, each of the plurality of radiant energy components 127 may include at least one of, a microwave component configured to generate microwave energy, a radiation component configured to generate radiation energy, and/or a magnet or magnetized component configured to generate magnetic fields. In the non-limiting example shown in FIGS. 1 and 2, and as discussed in detail below, the plurality of radiant energy components 127 may be formed from a microwave component or radiation component configured to generate radiant energy for sintering magnetic powder material 108.

Similar to the plurality of magnets 118, it is understood that the number of radiant energy components 127 of AMS 100 shown in the figures is merely illustrative. As such, AMS 100 may include more or less radiant energy components 127 than the number depicted and discussed herein. Additionally, the position and/or alignment of the plurality of radiant energy components 127 within build chamber 104 shown in the figures is merely illustrative. The plurality of radiant energy components 127 may be positioned or located in various locations of build chamber 104. Furthermore, the position/location and/or the alignment relation of each radiant energy component 127 may be dependent on, at least in part, the number of radiant energy components 127 included in AMS 10, the size and/or geometry of build chamber 104, and/or the size and/or geometry of the sintered component to be formed using AMS 100.

AMS 100 may also include at least one spray nozzle 128. As shown in FIGS. 1 and 2, AMS 100 may include a plurality of spray nozzles 128 positioned within build chamber 104. Specifically, the plurality of spray nozzles 128 may be positioned within build chamber 104, adjacent to and/or substantially surrounding magnet 118A. Additionally, the plurality of spray nozzles 128 may be positioned adjacent to, substantially above and/or may substantially surround build platform 102 and/or magnetic powder material 108 positioned on build platform 102. In non-limiting examples, spray nozzles 128 of AMS 100 may be fixed within build chamber 104, or alternatively, may be positioned on a track or moveable armature and may be configured to move within build chamber 104. In another non-limiting example, spray nozzles 128 may be positioned partially through a sidewall and/or may be formed integral with build chamber 104, such that only a portion of spray nozzles 128 extends into and/or is in fluid communication with cavity 106 of build chamber 104.

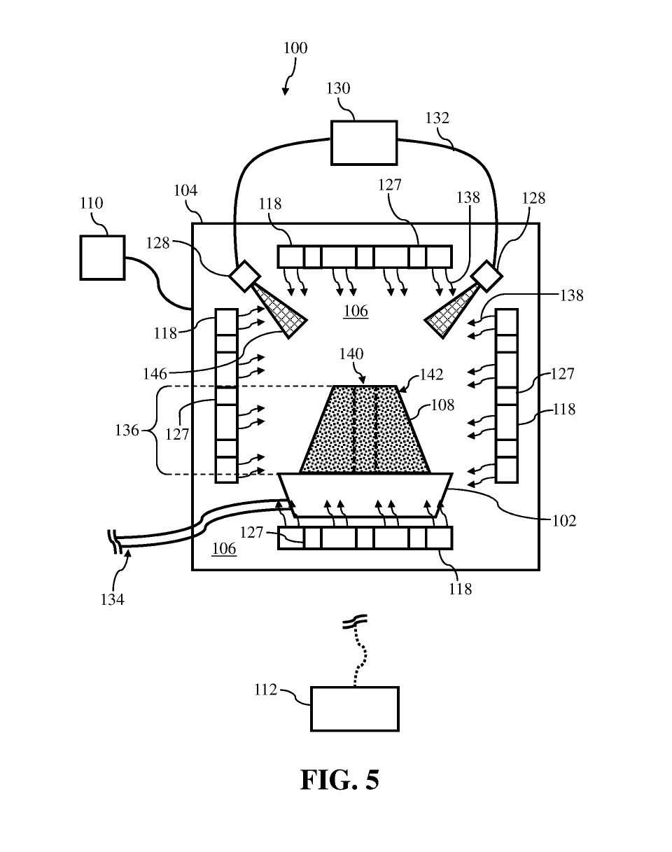

As discussed herein, spray nozzles 128 may be configured to coat a pre-sintered component made from magnetic powder material 108 with a binder material (see, FIG. 5) to maintain a geometry of the pre-sintered component during a sintering process. The binder material may be stored within a supply tank 130 of AMS 100. Supply tank 130 may be in fluid communication and/or fluidly coupled to spray nozzles 128 via conduits 132 to provide the binder material to spray nozzles 132 during the sintered component formation process discussed herein. As shown in FIGS. 1 and 2, controller 112 may be in electrical communication with each spray nozzle 128. Controller 112 may be configured to activate and/or engage spray nozzles 128 to spray and/or coat the pre-sintered component formed within build chamber 104 from magnetic powder material 108, as discussed herein.

It is understood that the number of spray nozzles 128 of AMS 100 shown in the figures is merely illustrative. As such, AMS 100 may include more or less spray nozzles 128 than the number depicted and discussed herein. Additionally, the position of spray nozzles 128 within build chamber 104 shown in the figures is merely illustrative. Spray nozzles 128 may be positioned or located in various locations of build chamber 104. Furthermore, the position and/or location each spray nozzle 128 may be dependent on, at least in part, the number of spray nozzles 128 included in AMS 10, the size and/or geometry of build chamber 104, the size and/or geometry of the sintered component to be formed using AMS 100, the composition of the binder material sprayed by spray nozzles 128 to coat the pre-sintered component and/or the ability for spray nozzles 128 to move within build chamber 104.

As shown in FIG. 1, AMS 100 may also include a material removal feature 134. Material removal feature 134 may be positioned within build chamber 104. Specifically, material removal feature 134 may be positioned within build chamber 104 and/or may be in (fluid) communication with cavity 106 of build chamber 104. Material removal feature 134 may be formed as any suitable component and/or device that may be configured to remove a non-manipulated portion of magnetic powder material 108 from build chamber 104 (see, FIG. 3). In a non-limiting example shown in FIG. 1, material removal feature 134 may be configured as a vacuum or a vacuum hose positioned on build platform 102 that may remove magnetic powder material 108 from build platform 102 and ultimately build chamber 104, as discussed herein. The non-manipulated portion of magnetic powder material 108 may be removed from build chamber 104 to prevent damage to the sintered component (see, FIG. 9) and/or prevent undesirable geometries or features from being formed on the sintered component during the formation process discussed herein.

A process for forming a sintered component form magnetic powder material 108 using AMS 100 may now be discussed with reference to FIGS. 3-9. It is understood that similarly numbered and/or named components may function in a substantially similar fashion. Redundant explanation of these components has been omitted for clarity. Additionally, controller 112 may not be shown to be in electrical communication with every magnet 118, spray nozzles 128 and/or heating component 110 as previously depicted. The communication lines from controller 112 to these various components of AMS 100 may be omitted in FIGS. 3-9 for clarity. As such, it is understood that controller 112 of AMS 100 may still be in electrical communication with magnets 118, spray nozzles 128 and/or heating component 110 as previously discussed and depicted herein with respect to FIGS. 1 and 2.

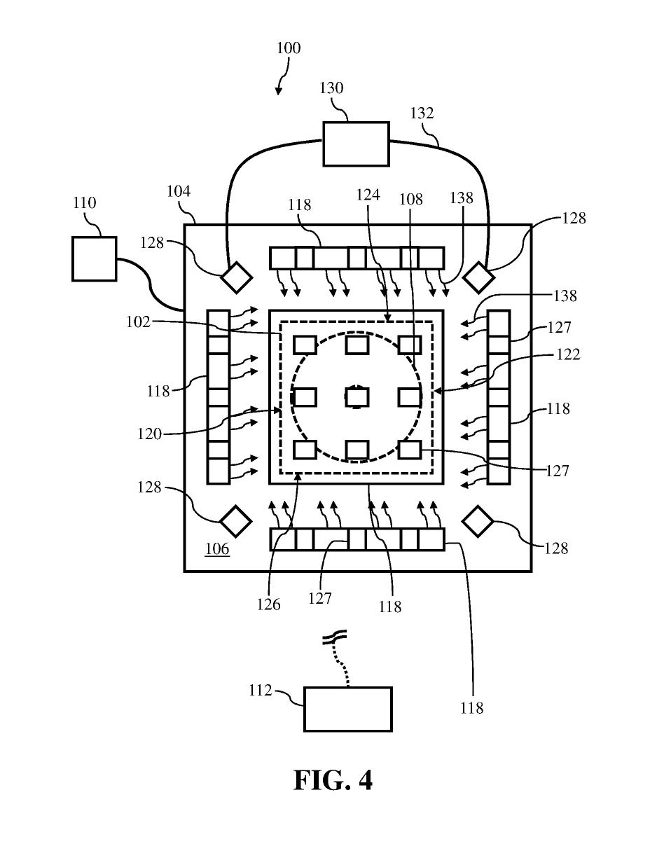

FIGS. 3 and 4 show a front and top view, respectively, of AMS 100 including magnetic powder material 108. FIGS. 3 and 4 depict a shaping, forming and/or manipulating process performed on magnetic powder material 108. That is, as shown in FIGS. 3 and 4, and distinct from FIGS. 1 and 2, AMS 100 may manipulate magnetic powder material 108 positioned on build platform 102 to form a pre-sintered component 136. Specifically, magnetic powder material 108 may be manipulated to form pre-sintered component 136 using controller 112 and the plurality of magnets 118. As shown in FIGS. 3 and 4, and discussed herein, the magnets or magnetized components forming each of the plurality of magnets 118 may generate and/or produce a magnetic wave or field 138, and may direct the magnetic field 138 toward build platform 102 to manipulate magnetic powder material 108. Controller 112 may adjust the operational characteristics of the plurality of magnets 118 to manipulate magnetic powder material 108 and form pre-sintered component 136 from the same. Adjusting the operational characteristics of the plurality of magnets 118 (see, FIGS. 1 and 2) may include activating at least a portion of the plurality of magnets 118, modifying a magnetic polarity for magnetic field 138 produced by each of the activated magnetized components of the plurality of magnets 118, and/or modifying the magnetic field strength of magnet field 138 generated by each of the activated magnetized components of the plurality of magnets 118.

Magnetic field 138 generated by each magnet or magnetized component of the plurality of magnets 118, and the adjustment to the operational characteristics of the magnets or magnetized components by controller 112, may form pre-sintered component 136. Specifically, magnetic field 138 directed toward magnetic powder material 108, and the adjusted operational characteristics for magnetic field 138, may manipulate at least a portion of magnetic powder material 108 to form pre-sintered component 136, having a geometry, on build platform 102 and/or within build chamber 104. The geometry of pre-sintered component 136 may be unique and/or include distinct features for the component. In a non-limiting example shown in FIGS. 3 and 4, pre-sintered component 136 may include features such as an aperture 140 formed through pre-sintered component 136, and substantially sloping or angular sidewalls 142 (see, FIG. 3). As discussed herein, the geometry and/or the features included within pre-sintered component 136 may be substantially identical to a geometry and/or features included on a sintered component (see, FIG. 9).

To form the geometry and/or features within pre-sintered component 136, magnetic fields 138 generated by each of the plurality of magnets 118 may interact, collide and/or repel each other to manipulate magnetic powder material 108. Additionally, the operational characteristics of each magnetic field 138 generated by magnets 118 may influence and/or alter how each magnetic field 138 of each magnet 118 interacts with distinct magnet field 138 from another magnet 118, which may in turn aid in the manipulation of magnetic powder material 108. In a non-limiting example, aperture 140 of pre-sintered component 136 may be formed using first magnet 118A and second magnet 118B. In the non-limiting example, a portion of the magnets or magnetized components in each of first magnet 118A and second magnet 118B may generate magnetic fields 138 that repel each other and/or repel magnetic powder material 108 to form aperture 140 in pre-sintered component 136.

In another non-limiting example, the operational characteristics for the plurality of magnets 118, and specifically magnets 118C, 118D, 118E, 118F, may be adjusted by controller 112 to formed angular sidewalls 142. Specifically, controller 112 may adjust the magnetic field strength for each magnet 118C, 118D, 118E, 118F such that the magnetic field strength for each magnet 118C, 118D, 118E, 118F may vary (e.g., increase or decrease) based on the proximity of the magnetized component to first magnet 118A, second magnet 118B, and/or build platform 102. Additionally in other non-limiting examples, the interaction of the magnetic fields generated by the plurality of magnets 118 may be manipulated to create “magnetic dead zones” and/or voids or areas of no magnetic attraction for magnetic powder material 108. As such, no magnetic powder material 108 may be formed or positioned within these magnetic dead zones, which may result in voids, apertures, internal spaces and/or passages within pre-sintered component 136.

It is understood that the geometry and/or features for pre-sintered component 136 depicted in FIGS. 3 and 4 are merely illustrative. As such, pre-sintered component 136 may include a variety of features that are unique and/or crucial to the component being formed by AMS 100. These variety of features may be formed by adjusting any or all of the operational characteristics of the plurality of magnets 118 as discussed herein.

Additionally as shown in FIG. 3, a non-manipulated portion 144 (shown in phantom) of magnetic powder material 108 may be removed from build chamber 104. Specifically, material removal feature 134 of AMS 100 may remove non-manipulated portion 144 of magnetic powder material 108 from cavity 106 of build chamber 104. Material removal feature 134 may remove non-manipulated portion 144 of magnetic powder material 108 after pre-sintered component 136 is formed. This ensures AMS 100 has the desired and/or required amount of magnetic powder material 108 to form pre-sintered component 136 using the plurality of magnets 118. In a non-limiting example, material removal feature 134, which may be configured as a vacuum hose, may be in communication with the surface of build platform 102 in which pre-sintered component 136 is formed. After pre-sintered component 136 is formed on build platform 102, material removal feature 134 (e.g., vacuum hose) may remove (e.g., suction) non-manipulated portion 144 of magnetic powder material 108 that is not included and/or used to form pre-sintered component 136. The removal process (e.g., vacuuming or suction) may not disrupt, alter, affect and/or remove any of magnetic powder material 108 being used to form pre-sintered component 136. In the non-limiting example, the vacuum or suction force of the vacuum hose forming material removal feature 134 may not be stronger than the magnetic field strength of the plurality of magnets 118 used to manipulate magnetic powder material 108 to form pre-sintered component 106. As such, no magnetic powder material 108 may be removed from pre-sintered component 136 when vacuum hose removes or sucks non-manipulated portion 144 of magnetic powder material 108 from cavity 106. As discussed herein, non-manipulated portion 144 of magnetic powder material 108 may be removed from cavity 106 of build chamber 104 to prevent damage to the sintered component (see, FIG. 9) and/or prevent undesirable geometries or features from being formed on the sintered component during the formation process.

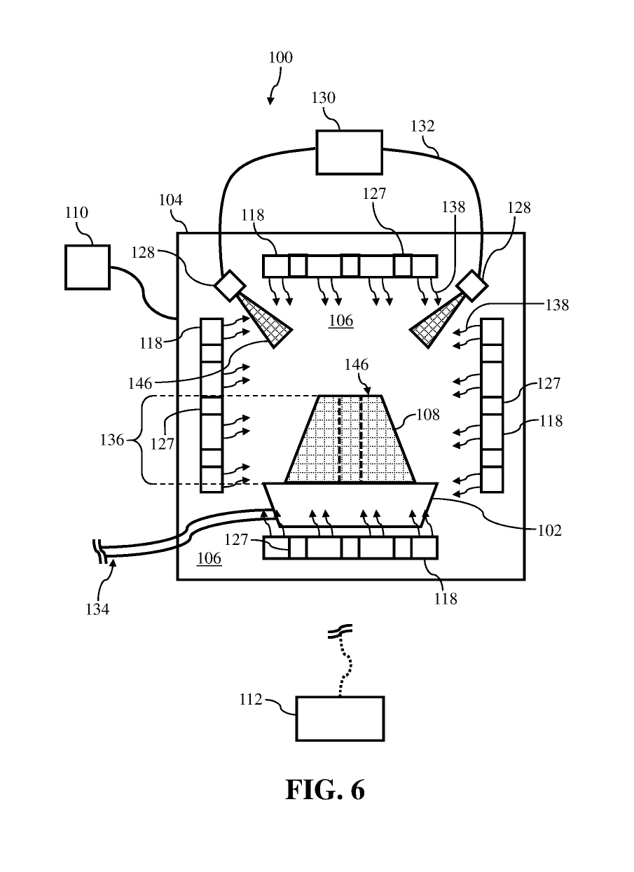

FIGS. 5 and 6 depict pre-sintered component 136 undergoing a covering or coating process. Specifically, after the manipulation of magnetic powder material 108 to form pre-sintered component 136, spray nozzles 128 of AMS 100 may cover or coat pre-sintered component 136 with a binder material 146 stored and/or supplied by supply tank 130. As discussed herein, controller 112 may be in electrical communication with and may activate spray nozzles 128 to cover or coat pre-sintered component with binder material 146 (see, FIG. 6). In a non-limiting example, spray nozzles 128 of AMS 100 may cover or coat pre-sintered component 136 by spraying a liquid binder material 146 directly on pre-sintered component 136 formed from magnetic powder material 108. Spray nozzles 128 may spray binder material 146 directly on pre-sintered component 136 to ensure all portions, geometries and/or features (e.g., aperture 140, angular sidewalls 142) of pre-sintered component 136 are coated with binder material 146. As discussed herein, spray nozzles 128 may be configured to move within build chamber 104 during the covering or coating process to ensure a desired or complete coverage of pre-sintered component 136 with binder material 146. Binder material 146 covering or coating pre-sintered component 136 may be any suitable binder, adhesive and/or curable material that may maintain the geometry of pre-sintered component 136 after covering or coating magnetic powder material 108 forming pre-sintered component 136. As discussed herein, covering or coating pre-sintered component 136 with binder material 146 may ensure magnetic powder material 108 maintains its shape or geometry even after pre-sintered component 146 is heated beyond a Curie temperature or Curie point for magnetic powder material 108 (e.g., temperature that magnetic powder material 108 loses its permanent magnetic properties) during a heating or sintering process.

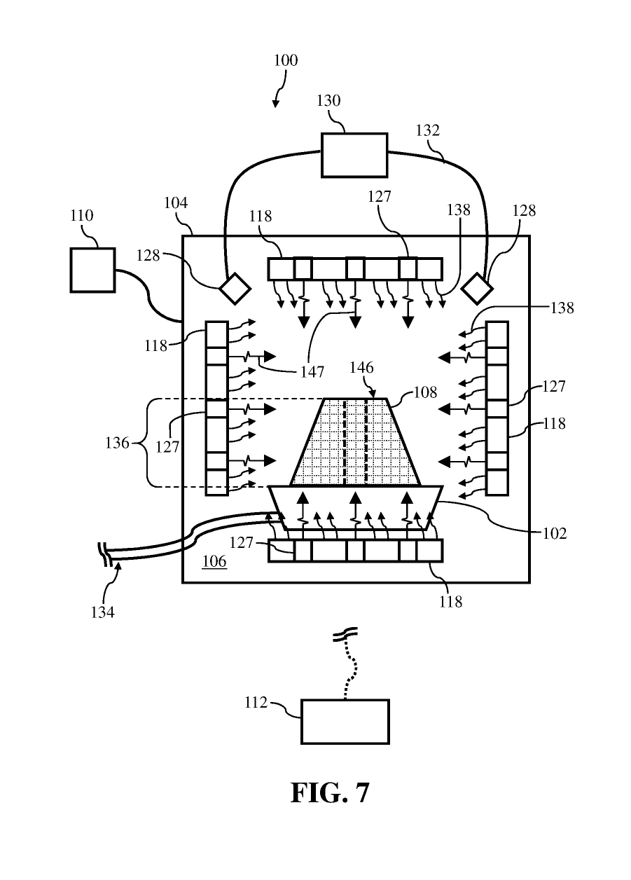

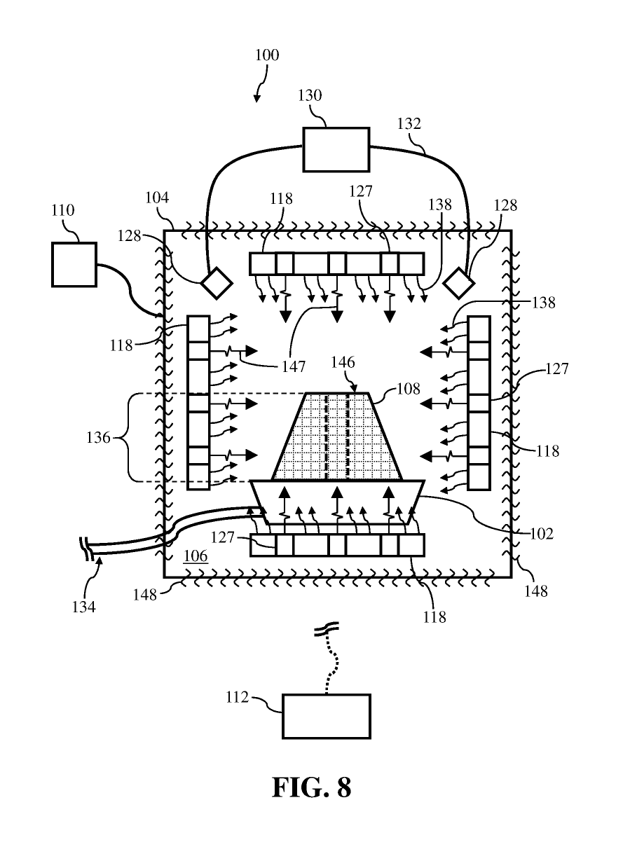

FIGS. 7 and/or 8 depict pre-sintered component 136 undergoing sintering or heating processes. Specifically, FIG. 7 may depict processes of forming the sintered component from pre-sintered component 136, as depicted in FIG. 9, and FIG. 8 may depict an auxiliary process for aiding in the formation of the sintered component from pre-sintered component 136. As such, and as discussed herein, the sintered component formed from pre-sintered component 136 may be formed with or without undergoing the processes discussed herein with respect to FIG. 8.

In a non-limiting where FIG. 7, pre-sintered component 136 may be covered and/or coated with binder material 146, and the plurality of radiant energy components 127 may generate, emit and/or produce radiant energy or radiant energy waves 147 (hereafter, “radiant energy 147”). As discussed herein, controller 112 may activate and/or engage the plurality of radiant energy components 127, which in turn allows the plurality of radiant energy components 127 to generate, emit and/or produce radiant energy 147 directed directly toward pre-sintered component 136 to heat and/or sinter pre-sintered component 136. That is, radiant energy 147 generated by the plurality of radiant energy component 127 may provide a desired amount of energy to heat and/or sinter pre-sintered component 136. In a non-limiting example, and as discussed herein, the plurality of radiant energy components 127 may be configured or formed from a microwave component, and radiant energy 147 generated by the plurality of radiant energy components 127 for sintering pre-sintered component 136 may include microwave energy. In another non-limiting example, the plurality of radiant energy components 127 may be configured or formed from a radiation component. In the non-limiting example, radiant energy 147 generated by the radiation component forming the plurality of radiant energy components 127 may include radiation energy or radiation waves.

In the non-limiting example shown in FIG. 7, the plurality of radiant energy components 127 may begin generating radiant energy 147 during a sintering process of pre-sintered component 136 after spray nozzles 128 have covered or coated pre-sintered component 136 with binder material 146 and subsequently shut down or stopped spraying. Where binder material 146 is formed from a material that is affected and/or altered by heat (e.g., radiant energy 147), preforming these processes (e.g., covering then heating) as discussed herein may prevent the alteration of binder material 146 used to cover or coat pre-sintered component 136. In another non-limiting example discussed herein, the plurality of radiant energy components 127 may begin to generate radiant energy 147 and/or may begin to heat or sinter pre-sintered component 136 while spray nozzles 128 continue to cover or coat pre-sintered component 136 with binder material 146.

In the non-limiting example shown in FIG. 7, the plurality of magnets 118 of AMS 100 may remain activated and/or may continue to generate magnetic fields 138 the plurality of radiant energy components 127 begin to heat and/or sinter pre-sintered component 136. That is, magnetic fields 138 generated by the plurality of magnets 118 may be continually directed toward pre-sintered component 136 formed from magnetic powder material 108 after pre-sintered component 136 is covered or coated in binder material 146 and/or after the plurality of radiant energy components 127 begins producing radiant energy 147. Although it is discussed herein that binder material 146 covering or coating pre-sintered component 136 maintains the geometry of pre-sintered component 136, the plurality of magnets 118 may continue to generate magnetic fields 138 during at least a portion of the heating or sintering process to ensure or provide a precautionary measure or process and/or ensure pre-sintered component 136 maintains its geometry.

In a non-limiting example (not shown), the plurality of magnets 118 (see, FIGS. 1 and 2) may be deactivated at later time during the heating or sintering process. That is, subsequent to the plurality of radiant energy components 127 beginning to generate radiant energy 147, but prior to completely sintering or forming the sintered component (see, FIG. 9), controller 112 may deactivate or shut down operations of the plurality of magnets 118 such that the plurality of magnets 118 no longer generate magnetic fields 138. The plurality of magnets 118 may be deactivated or shut down by controller 112 after pre-sintered component 136 formed from magnetic powder material 108 is heated to or beyond its Curie temperature or Curie point. That is, controller 112 may deactivated or shut down the plurality of magnets 118 once pre-sintered component 136 reaches a temperature that magnetic powder material 108 loses its permanent magnetic properties and/or may no longer be manipulated by magnetic fields 138. As discussed herein, binder material 146 covering or coating pre-sintered component 136 maintains the geometry of pre-sintered component 136 while the plurality of radiant energy components 127 continue to generate and/or produce radiant energy 147 to heat or sinter pre-sintered component 136.

In another non-limiting example, the plurality of magnets 118 may continuously generate magnetic fields 138 until magnetic powder material 108 forming pre-sintered component 136 is sintered. Distinct from the example discussed above, controller 112 may maintain operation of the plurality of magnets 118 and/or the generation of magnetic fields 138 through the heating of magnetic powder material 108 to or above a Curie temperature or Curie point. As discussed herein, controller 112 may deactivate or shut down the plurality of magnets 118 only after pre-sintered component 136 has been fully sintered and/or magnetic powder material 108 has been heated to a sintering temperature for a predetermined amount of time to sinter magnetic powder material 108 forming pre-sintered component 136.

In an additional non-limiting example, the plurality of magnets 118 may be deactivated or shut down by controller 112 after pre-sintered component 136 is covered or coated with binder material 146. Distinct from the examples discussed above, controller 112 may deactivate or shut down the plurality of magnets 118, and stop the generation of magnetic fields 148 by the plurality of magnets 118, subsequent to pre-sintered component 136 being covered or coated with binder material 146. Additionally, in the non-limiting example, controller 112 may deactivate or shut down the plurality of magnets 118 before the plurality of radiant energy components 127 produce or generate radiant energy 147 to being heat or sinter pre-sintered component 136, as discussed herein.

Turning to FIG. 8, an auxiliary, additional and/or optional processes for forming a sintered component (see, FIG. 9) using AMS 100 is depicted. As discussed herein, build chamber 104 may be utilized and/or may function as a heat source. That is, build chamber 104 may be coupled and/or connected to a heating component 110, which may be activated by controller 112 to heat build chamber 104 and/or allow build chamber to heat cavity 106 and/or pre-sintered component 136. In the non-limiting example shown in FIG. 8, the heat 148 generated by build chamber 104 may aid in the formation of the sintered component and/or sintering pre-sintered component 136. Specifically, heat 148 generated by build chamber 104 may aid in the sintering process performed on pre-sintered component 136 by the plurality of radiant energy components 127 generating radiant energy 147 by providing additional heat to cavity 106 of build chamber 104 and/or pre-sintered component 136. As discussed herein, the plurality of radiant energy components 127 and the resulting radiant energy 147 produced and/or generated by the plurality of radiant energy components 127 may be enough energy and/or heat to sinter pre-sintered component 136 without the aid of heat 148 from build chamber 104. However, the inclusion of heat 148 produced by build chamber 104 may aid, help and/or expedite the sintering process performed on pre-sintered component 136.

FIG. 9 depicts a front view of AMS 100 and a sintered component 150 formed by AMS 100 after performing the sintered component formation process discussed herein. Specifically, FIG. 9 depicts formed sintered component 150 after undergoing a material manipulating process (e.g., FIGS. 3 and 4), a covering or coating process (e.g., FIGS. 5 and 6) and a heating or sintering process (e.g., FIGS. 7 and/or 8) performed by AMS 100 and its various components (e.g., build platform 102, build chamber 104, magnets 118, the plurality of radiant energy components 127, and so on). As shown in FIG. 9, and with comparison to FIG. 3, magnetic powder material 108 has been sintered by radiant energy 147 (e.g., microwave energy, radiation energy waves) generated by the plurality of radiant energy components 127 (e.g., microwave component, radiation component). As a result, the physical, chemical, material and/or mechanical properties of sintered component 150 may be distinct and/or altered from those properties of magnetic powder material 108 forming pre-sintered component 136 (see. FIG. 3). Although the properties (e.g., strength) of sintered component 150 may be distinct or different from magnetic powder material 108 forming pre-sintered component 136, the geometry of sintered component 150 may be the same or substantially identical to pre-sintered component 136. That is, sintered component 150 may include a geometry that is substantially the same or substantially identical to the geometry of pre-sintered component 136. For example, sintered component 150 may include aperture 140 and angular sidewalls 142. Once formed, sintered component 150 may be removed from build chamber 104 of AMS 100 and may undergo final component processing (e.g., polishing, buffing, grinding) and/or may be implemented within a system or machine that utilizes sintered component 150 during operation. In a non-limiting example, sintered component 150 may undergo a heat-treating process to remove (e.g., burn out) at least a portion of binder material 146 that may fuse and/or be formed within the sintered component 150 as a result of the covering/coating and/or sintering processes, as discussed herein.

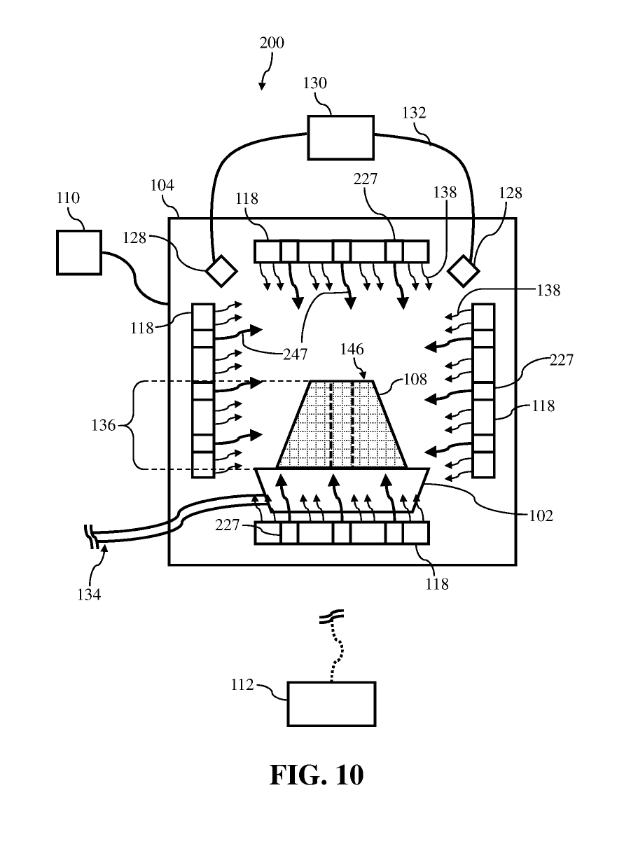

FIGS. 10-14 depict further non-limiting examples of AMS 200, 300, 400. Specifically, FIGS. 10-14 each depict distinct, non-limiting examples of distinct radiant energy components 227, plurality of magnets 318 and/or magnetic coils 452 of AMS 200, 300, 400. It is understood that similarly numbered and/or named components may function in a substantially similar fashion. Redundant explanation of these components has been omitted for clarity.

As shown in FIG. 10, and as previously discussed herein with reference to FIGS. 1 and 2, the plurality of radiant energy components 227 of AMS 200 may be configured as and/or formed from a magnetized component. The magnetized component forming the plurality of radiant energy components 227, as shown in FIG. 10, may be distinct from the magnets and/or magnetic components forming each of the plurality of magnets 118 discussed herein. Similar to the plurality of magnets 118, the magnetized component forming the plurality of radiant energy components 227 may be configured to generate, emit and/or produce a magnetic field (e.g., radiant energy 247). Specifically, the radiant energy 247 generated, emitted and/or produced by the magnetized component forming the plurality of radiant energy components 227 may be a magnetic field that may include operational characteristics that may heat, vibrate and/or sinter magnetic powder material 108 forming pre-sintered component 136 to form sintered component 150 (see, FIG. 9). The operational characteristics for radiant energy 247 or magnetic field generated by the plurality of radiant energy components 227 may be substantially similar to the operational characteristics discussed herein with respect to magnetic field 138 generated by the plurality of magnets 118 (e.g., magnetic polarity, magnetic field strength, and so on).

In the non-limiting example shown in FIG. 10, controller 112 may be electrically coupled and/or in electronic communication with each magnetized component forming the plurality of radiant energy components 227 in a similar fashion as discussed herein with respect to controller 112 and the plurality of magnets 118 (see, FIGS. 1 and 2). Additionally, and as similarly discussed herein with respect to controller 112 and the plurality of magnets 118, controller 112 may be configured to adjust the operational characteristics of the plurality of radiant energy components 227. That is, controller 112 may activate and/or engage the plurality of radiant energy components 227 to generate, emit and/or produce radiant energy 247 or a magnetic field directed directly toward pre-sintered component 136, and may adjust the operational characteristics for the magnetic field forming radiant energy 247. In the non-limiting example depicted in FIG. 10, radiant energy 247, and specifically the magnetic field, generated by the magnetized component forming the plurality of radiant energy components 227 may include distinct operational characteristics than magnetic field 138 generated by the plurality of magnets 118. Specifically, magnetic field forming radiant energy 247 may include a first magnetic field strength that is greater than a second magnetic field strength of magnetic field 138 generated by the plurality of magnets 118.

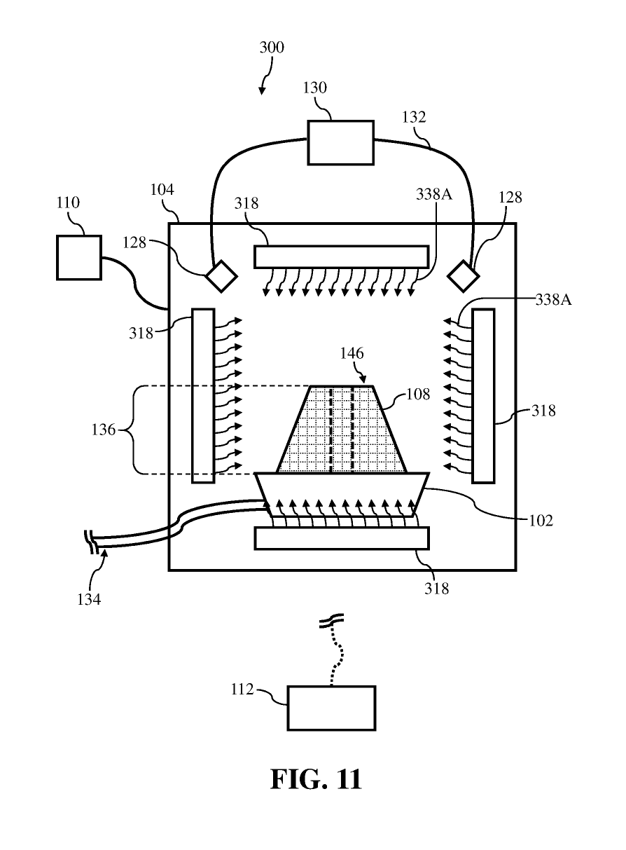

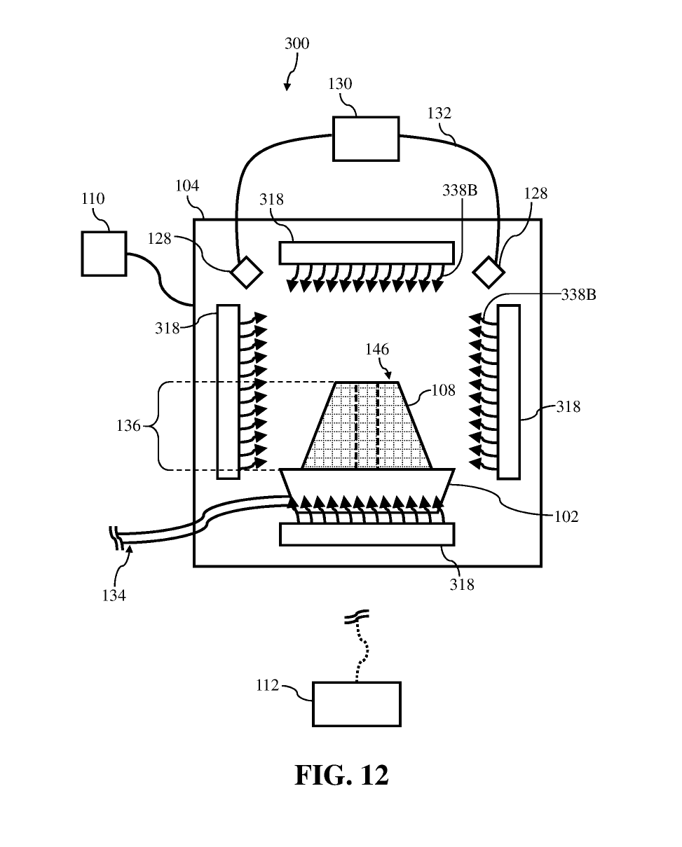

FIGS. 11 and 12 depict another non-limiting example of AMS 300. As shown in FIGS. 11 and 12, and with comparison to FIGS. 1-10, AMS 300 may not include the plurality of radiant energy components discussed herein. Rather, AMS 300 may include only the plurality of magnets 318 that may be configured to both manipulate magnetic powder material 108 to form pre-sintered component 136 and sinter pre-sintered component 136 to form sintered component 150 (see, FIG. 9). As similarly discussed herein, controller 112 may be in electronic communication with each of the plurality of magnets 318, and may be configured to activate, engage and/or adjust the operational characteristics of the plurality of magnets 318 to generate magnetic field 338A, 338B. Turning to FIG. 11, controller 112 may activate the plurality of magnets 318 to generate magnetic field 338A having a first magnetic field strength. Magnetic field 338A having the first magnetic field strength may manipulate magnetic powder material 108 to form pre-sintered component 136, as similarly discussed herein with respect to FIGS. 3 and 4. Redundant explanation of manipulating magnetic powder material 108 using the plurality of magnets 318 may be omitted for clarity.

Turning to FIG. 12, controller 112 may adjust the operational characteristics the plurality of magnets 318 to generate magnetic field 338B having a second magnetic field strength. Specifically, controller 112 may adjust the operational characteristics the plurality of magnets 318, such that the generated magnetic field 338B includes a second magnetic field strength that may be greater or larger than the first magnetic field strength of generated magnetic field 338A, as shown and discussed herein with respect to FIG. 11. Magnetic field 338B including the second (larger) magnetic field strength may be utilized to sinter magnetic powder material 108 forming pre-sintered component 136. That is, and as similarly discussed herein with respect to radiant energy 247 depicted in FIG. 10, magnetic field 338B having second magnetic field strength may heat, vibrate and/or sinter magnetic powder material 108 forming pre-sintered component 136 to form sintered component 150 (see, FIG. 9). Magnetic field 338B having second magnetic field strength may also manipulate and/or maintain the shape or geometry of pre-sintered component 136 during the sintering process, as discussed herein. Additionally, or alternatively, pre-sintered component 136 formed from magnetic powder material 108 may also maintain its shape or geometry as a result of being covered and/or coated in binder material 146, as similarly discussed herein with respect to FIGS. 5-7.

It is understood that the number of magnets 318 of AMS 300 shown in the figures is merely illustrative. As such, AMS 300 may include more or less magnets 318 than the number depicted and discussed herein. Additionally, the position and/or alignment of the plurality of magnets 318 within build chamber 104 shown in the figures is merely illustrative. The plurality of magnets 318 may be positioned or located in various locations of build chamber 104. Furthermore, the position/location and/or the alignment relation of each magnet 318 may be dependent on, at least in part, the number of magnets 318 included in AMS 300, the size and/or geometry of build chamber 104, and/or the size and/or geometry of the sintered component to be formed using AMS 300.

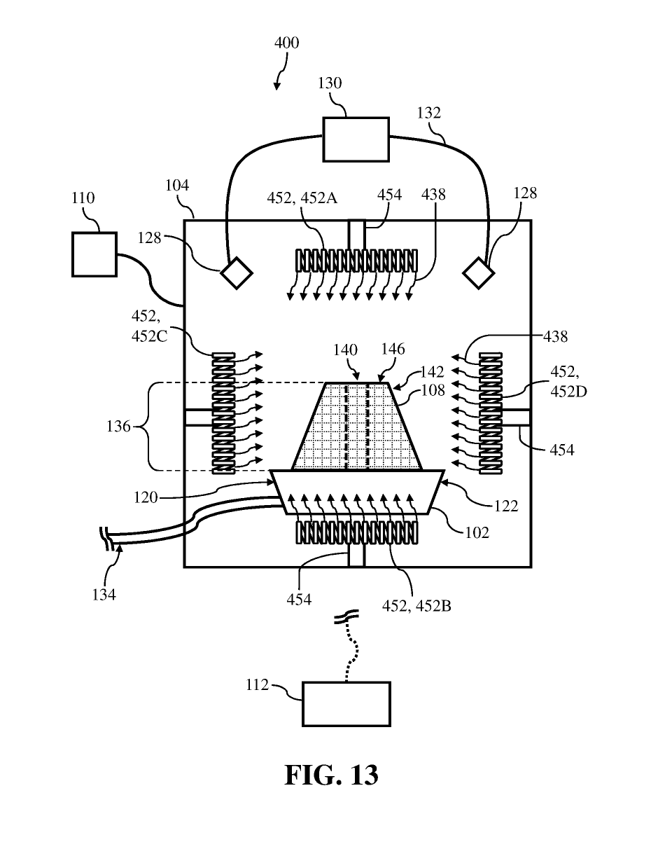

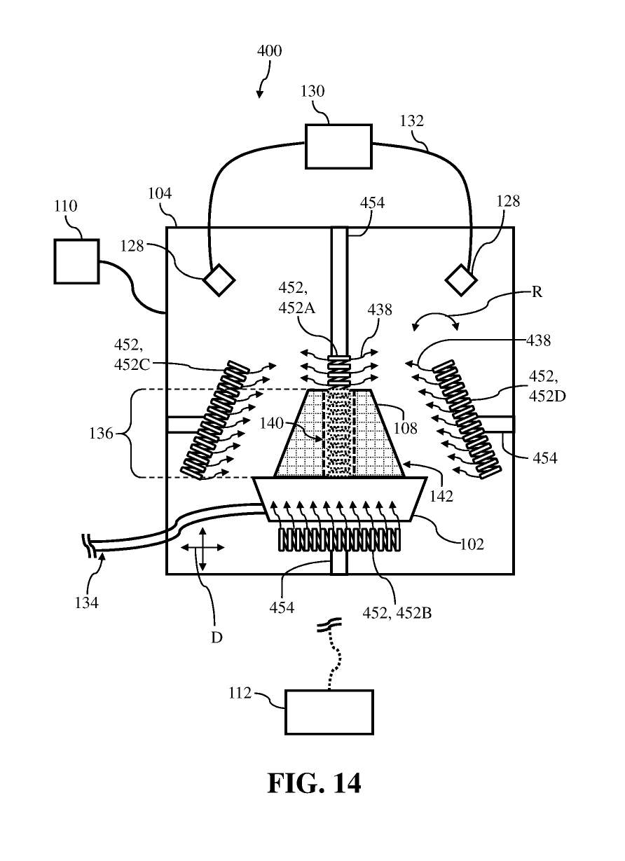

FIGS. 13 and 14 depict another non-limiting example of AMS 400. AMS 400 may include at least one magnetic coil 452 positioned adjacent build platform 102. Specifically, AMS 400 may include a plurality of magnetic coils 452 that may be positioned adjacent to and/or substantially surround build platform 102. The plurality of magnetic coils 452 may replace and/or be included within AMS 400 in place of the plurality of magnets 118, as discussed herein with respect to FIGS. 1-10. The plurality of magnetic coils 452 may include a first magnetic coil 452A positioned, at least partially, above build platform 102 (compare, FIG. 13 with FIG. 14), and a second magnetic coil 452B positioned below magnetic powder material 108 positioned on build platform 102. As shown in FIG. 13, second magnetic coil 452B may be positioned opposite and/or may be substantially aligned (e.g., vertically) with first magnetic coil 452A. In the non-limiting example shown, second magnetic coil 452B may be positioned below build platform 102. In another non-limiting example (not shown), second magnetic coil 452B may be positioned, formed integral, and/or formed within build platform 102. In the other non-limiting example, second magnetic coil 452B formed within build platform 102 may be positioned below magnetic powder material 108 disposed on build platform 102 within build chamber 104.

The plurality of magnetic coils 452 of AMS 400 shown in FIGS. 13 and 14 may also include magnetic coils 452C, 452D that are positioned substantial adjacent to, in line with and/or surround build platform 102 and magnetic powder material 108, respectively. With reference to FIGS. 13 and 14, magnetic coil 452C, 452D may be positioned on distinct sides of build platform 102 and magnetic powder material 108, respectively. Specifically, third magnetic coil 452C may be positioned adjacent a first side 120 of build platform 102, and fourth magnetic coil 452D may be positioned on a second side 122 of build platform 102, opposite first side 120 and/or third magnetic coil 452C. Similar to first magnetic coil 452A and second magnetic coil 452B, third magnetic coil 452C may be positioned opposite to and/or may be substantially aligned with fourth magnetic coil 452D of the plurality of magnetic coils 452.

It is understood that the number of magnetic coils 452 of AMS 400 shown in the figures is merely illustrative. As such, AMS 400 may include more or less magnetic coils 452 than the number depicted and discussed herein. Additionally, the position and/or alignment of the plurality of magnetic coils 452 within build chamber 104 shown in the figures is merely illustrative. The plurality of magnetic coils 452 may be positioned or located in various locations of build chamber 104. Furthermore, the position/location and/or the alignment relation of each magnetic coil 452 may be dependent on, at least in part, the number of magnetic coils 452 included in AMS 400, the size and/or geometry of build chamber 104, and/or the size and/or geometry of the sintered component to be formed using AMS 400.

As shown in FIGS. 13 and 14, each of the plurality of magnetic coils 452 may be configured to move. Specifically, each of the plurality of magnetic coils 452 of AMS 400 may be coupled to at least one actuator 454 (one shown) that may be configured to move and/or adjust a positioned of at least one or each of the plurality of magnetic coils 452 within cavity 106 of AMS 400. In the non-limiting example shown in FIGS. 13 and 14, actuator 454 may be configured to move each of the plurality of magnetic coils 452 in a linear direction (D) and/or in a rotational direction (R). The movement of each of the plurality of magnetic coils 452 and/or the position of each of the plurality of magnetic coils 452 with respect to build platform 102 may aid in the manipulation of magnetic powder material 108, the formation of pre-sintered component 136, and/or the sintering of pre-sintered component 136 to form sintered component 150 (see, FIG. 9). In a non-limiting example shown in FIG. 14, first magnetic coil 452A may be moved, rotated, adjusted and/or positioned directly adjacent or on build platform 102 to help manipulate magnetic powder material 108 when forming pre-sintered component 136. Specifically, first magnetic coil 452A may be positioned adjacent or on build platform 102 and may be substantially surrounded by magnetic powder material 108 to form aperture 140 within pre-sintered component 136. As discussed herein, first magnetic coil 452A, along with the other magnetic coils 452B, 452C, 452D, may form aperture 140 within per-sintered component 136 by emitting magnetic fields 438 that may interact (e.g., repel, attract) with magnetic powder material 108 and each other. As such, additional operational characteristics that may be adjusted by controller 112 may include a distance between the plurality of magnetic coils 452 and magnetic powder material 108 forming pre-sintered component 136 and/or a position of the plurality of magnetic coils 452 within build chamber 104. For example, controller 112 may angle or rotate magnetic coils 452C, 452D, in a direction (R) to aid in the formation of angular sidewalls 142 of pre-sintered component 136.

Similar to the plurality of magnets 118 discussed herein, the plurality of magnetic coils 452 may be configured to manipulate magnetic powder material 108 to form pre-sintered component 136. Specifically, controller 112 may be in electronic communication with each of the plurality of magnetic coils 452, and may be configured to activate, engage and/or adjust the operational characteristics of the plurality of magnetic coils 452 to generate magnetic field 438. Magnetic field 438 generated by the plurality of magnetic coils 452 may manipulate magnetic powder material 108 to form pre-sintered component 136, as similarly discussed herein with respect to FIGS. 3 and 4. Redundant explanation of manipulating magnetic powder material 108 using the plurality of magnetic coils 452 may be omitted for clarity.

Additionally, and similar to the plurality of magnets 318 discussed herein with respect to FIG. 12, the plurality of magnetic coils 452 may be configured to form sintered component 150 (see, FIG. 9). Specifically, controller 112 may adjust the operational characteristics of the plurality of magnetic coils 452 to increase the magnetic field strength of magnetic field 438 to heat, vibrate and/or sinter pre-sintered component 136 formed from magnetic powder material 108. As similarly discussed herein with respect to radiant energy 247 depicted in FIG. 10 and/or second magnetic field 338 in FIG. 12, increasing the magnetic field strength of magnetic field 438 generated by each of the plurality of magnetic coils 452 may heat, vibrate and/or sinter magnetic powder material 108 forming pre-sintered component 136 to form sintered component 150 (see, FIG. 9). Redundant explanation of sintering pre-sintered component 138 using the plurality of magnetic coils 452 may be omitted for clarity.

In a non-limiting example, build chamber 104 may aid and/or be utilized to form sintered component 150 (see, FIG. 9). That is, build chamber 104 may be utilized and/or may function as a heat source and generate heat 148 (see, FIG. 8). As similarly discussed herein with respect to FIG. 8, the heat 148 generated by build chamber 104 may aid in the formation of sintered component 150 and/or sintering pre-sintered component 136. Specifically, heat 148 generated by build chamber 104 may aid in the sintering process performed on pre-sintered component 136 by the plurality of magnetic coils 452 generating magnetic fields 438 by providing additional heat to cavity 106 of build chamber 104 and/or pre-sintered component 136.

In another non-limiting example, the plurality of magnetic coils 452 may only be configured to generate magnetic field 438 that may manipulate magnetic powder material 108 to form pre-sintered component 136. As a result, the plurality of magnetic coils 452 may not be configured and capable of sintering pre-sintered component 136, as discussed herein. In this non-limiting example, build chamber 104 may be configured to heat and/or sinter pre-sintered component 136 to form sintered component 150 (see, FIG. 9). That is, build chamber 104 may be configured to produce heat 148 to heat or sinter pre-sintered component 136. As discussed herein, controller 112 may activate heat source 110 to provide energy (e.g., electricity) to heated build chamber 104, which in turn allows heated build chamber 104 to generate or produce heat 148 to heat cavity 106 and pre-sintered component 136.

Although shown as distinct, non-limiting examples, it is understood that various components of the AMS 100, 200, 300, 400 discussed herein may be used together. In a non-limiting example, the plurality of magnets 118, 318 (see, FIGS. 1 and 11) may be coupled to actuator 454 (see, FIG. 13), and actuator 454 may be configured to move and/or adjust a position of the plurality of magnets 118, 318 within build chamber 104. In another non-limiting example, it is understood that at least two of the plurality of magnets 118, 318, the plurality of radiant energy components 127 and/or the plurality of magnetic coils 452 may be included within a single AMS. As such, sintered component 150 (see, FIG. 9) may be formed from a single AMS that includes at least two of the plurality of magnets 118, 318, the plurality of radiant energy components 127 and the plurality of magnetic coils 452.

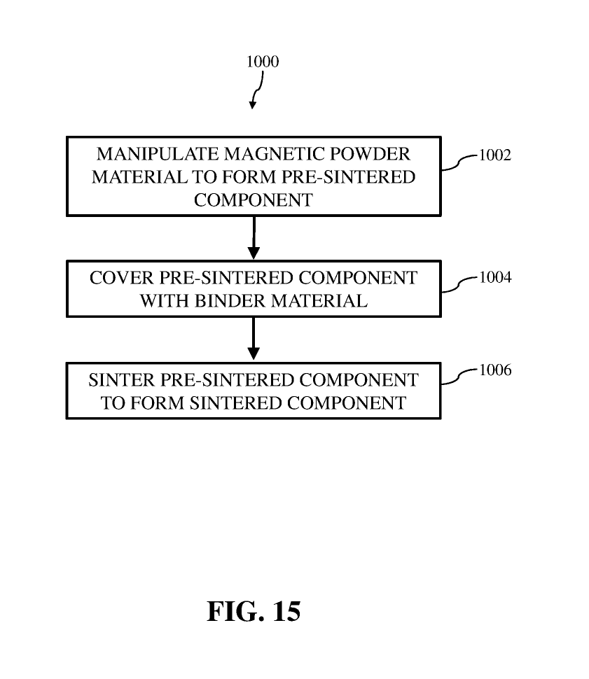

FIG. 15 shows an example process for forming a sintered component using an additive manufacturing system (hereafter, “AMS”). Specifically, FIG. 15 is a flowchart depicting one example process 1000 for forming a sintered component from a pre-sintered component using magnetic waves. In some cases, the process may be used to form sintered component 150, as discussed herein with respect to FIGS. 1-14.

In operation 1002, a magnetic powder material may be manipulated. The magnetic powder material may be manipulated using magnetic waves to form a pre-sintered component having a first geometry. Manipulating the magnetic powder to form the pre-sintered component may include adjusting operational characteristic(s) of a plurality of magnets or magnetic coils of the AMS that may substantially surround and/or be positioned adjacent the magnetic powder material. Adjusting the operational characteristic(s) of the plurality of magnets or magnetic coils of the AMS may include, but is not limited to, activating at least one of the plurality of magnets or magnetic coils, modifying a magnetic polarity of at least one of the magnets or magnetic coils, modifying a magnetic field strength of at least one of the magnets or magnetic coils, changing a distance between at least one magnet or magnetic coils and the magnetic powder material, and/or changing a position of the at least one magnet or magnetic coils of the AMS.

In operation 1004, the pre-sintered component formed from the magnetic powder material may be covered or coated with a binder material. The pre-sintered component may be covered or coated with a liquid binder material, a vapor binder material or any other suitable binder, adhesive and/or curable material that may maintain the geometry of the pre-sintered component 136 after covering or coating. In a non-limiting example, covering or coating the pre-sintered component with the binder material may include spraying the binder material directly on the pre-sintered component. In another non-limiting example covering or coating the pre-sintered component with the binder material may include dispensing into or flooding a cavity containing the pre-sintered component to coat or cloak the pre-sintered material with the binder material.

In operation 1006, the pre-sintered component may be sintered to form the sintered component. Sintering the pre-sintered component may include heating the pre-sintered component using a radiant energy and/or radiant energy waves. For example, a plurality of radiant energy components (e.g., distinct magnetic components, microwave components, radiation components and so on) may direct radiant energy waves (magnetic wave, microwave, radiation, and so on) toward the pre-sintered component to sinter and/or heat the pre-sintered component to form the sintered component. Additionally, or alternatively, the plurality of magnets or magnetic coils may increase a field strength of a radiant energy or magnetic wave directed toward the pre-sintered component to cause the molecules of the pre-sintered component vibrate and consequently, sinter. Additionally, the build chamber containing the pre-sintered component may also be heated to aid in the formation of the sintered component using radiant energy. The pre-sintered component may be sintered and/or heated until the magnetic powder material forming the pre-sintered component is heated to its sintering temperature to form the sintered component. The sintered component formed by sintering or heating the pre-sintered component may include a second geometry, which is substantially the same or substantially identical to the first geometry of the pre-sintered component.

Although shown in FIG. 15 as being performed linearly or in succession of one another, it is understood that at least some of the operations of process 1000 may be performed in distinct order than that shown, and/or may two or more operations may be formed simultaneously. For example, heating the pre-sintered component to sinter in operation 1006 may begin prior to, or at the same time as the pre-sintered component being covered with the binder material in operation 1004.

As discussed herein, controller 112 of AMS 100 may be implemented as or on a computer device or system (hereafter “computer”). Controller 112, as described herein, executes code that includes a set of computer-executable instructions defining sintered component 150 (see, e.g., FIG. 6) to first manipulate magnetic powder material 108 to form pre-sintered component 136 having the same geometry of sintered component 150, and subsequently have the plurality of radiant energy components 127, magnetic coils 452 and/or build chamber 104 sinter pre-sintered component 136 to form sintered component 150, as discussed herein. Controller 112, or the computer including controller 112, may include a memory, a processor, an input/output (I/O) interface, and a bus. Further, the computer may be configured to communicate with an external I/O device/resource and a storage system. In general, the processor executes computer program code that is stored in the memory and/or the storage system under instructions from the code representative of sintered component 150, described herein. While executing computer program code, the processor can read and/or write data to/from the memory, the storage system, and/or the I/O device. A bus provides a communication link between each of the components in controller 112 or the computer including controller 112, and the I/O device can comprise any device that enables a user to interact with controller 112 and/or the computer (e.g., keyboard, pointing device, display, etc.).

Controller 112 or the computer including controller 112 are only representative of various possible combinations of hardware and software. For example, the processor may comprise a single processing unit, or be distributed across one or more processing units in one or more locations, e.g., on a client and server. Similarly, the memory and/or the storage system may reside at one or more physical locations. The memory and/or the storage system can comprise any combination of various types of non-transitory computer readable storage medium including magnetic media, optical media, random access memory (RAM), read only memory (ROM), etc. Controller 112 or the computer including controller 112 can comprise any type of computing device such as a network server, a desktop computer, a laptop, a handheld device, a mobile phone, a pager, a personal data assistant, etc.

Additionally, and as discussed herein, the process of forming sintered component 150 may begin with a non-transitory computer readable storage medium (e.g., memory, storage system, etc.) storing code representative of sintered component 150. As noted, the code includes a set of computer-executable instructions defining sintered component 150 that can be used to physically generate the object, upon execution of the code by controller 112 or the computer including controller 112. For example, the code may include a precisely defined 3D model of sintered component 150 and can be generated from any of a large variety of well-known computer aided design (CAD) software systems such as AutoCAD®, TurboCAD®, DesignCAD 3D Max, etc. In this regard, the code can take any now known or later developed file format. Controller 112 or the computer including controller 112 executes the code, which in turn instructs AMS 100 and its various components to form sintered component 150 using the processes discussed herein.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An additive manufacturing system comprising:
a build platform;
at least one magnet positioned adjacent the build platform, the at least one magnet configured to manipulate a magnetic powder material positioned on the build platform to form a pre-sintered component having a first geometry;
at least one sprayer nozzle positioned adjacent the build platform, the at least one sprayer nozzle configured to coat the pre-sintered component formed from the magnetic powder material with a binder material; and
at least one radiant energy component positioned adjacent the build platform, the at least one radiant energy component configured to sinter the pre-sintered component to form a sintered component having a second geometry identical to the first geometry of the pre-sintered component.

2. The system of claim 1, further comprising:
a build chamber substantially surrounding the build platform, the build chamber configured to heat the pre-sintered component to aid in forming the sintered component.

3. The system of claim 1, further comprising:
a controller in electrical communication with:
the at least one magnet; and
the at least one radiant energy components.

4. The system of claim 1, wherein the at least one radiant energy component includes at least one of:
a magnetized component,
a microwave component, or
a radiation components.

5. The system of claim 4, wherein the magnetized component of the at least one radiant energy component is configured to generate a magnetic field having a first magnetic field strength for sintering the pre-sintered component.

6. The system of claim 5, wherein the at least one magnet includes:
a distinct magnetized component distinct from the magnetized component of the at least one radiant energy component, the distinct magnetized component configured to generate a magnetic field having a second magnetic field strength for manipulating the magnetic powder material,
wherein the second magnetic field strength is weaker than the first magnetic field strength.

7. The system of claim 4, wherein the microwave component of the at least one radiant energy components is configured to generate microwave energy for heating the pre-sintered component.

8. The system of claim 4, wherein the radiation component of the at least one radiant energy component is configured to generate radiation energy for heating the pre-sintered component.

9. The system of claim 1, wherein the at least one radiant energy component is formed integral with the at least one magnet.

10. An additive manufacturing system comprising:
a build platform;
at least one magnetic coil positioned adjacent the build platform, the at least one magnetic coil configured to manipulate a magnetic powder material positioned on the build platform to form a pre-sintered component having a geometry; and
at least one sprayer nozzle positioned adjacent the build platform, the at least one sprayer nozzle configured to coat the pre-sintered component formed from the magnetic powder material with a binder material.

11. The system of claim 10, further comprising a build chamber substantially surrounding the build platform, the build chamber configured to heat the pre-sintered component to form a sintered component having a geometry identical to the geometry of the pre-sintered component.

12. The system of claim 10, further comprising:
a controller in electrical communication with the at least one magnet coil, the controller configured to adjust a strength of a magnetic field generated by the at least one magnet coil.

13. The system of claim 10, wherein the at least one magnetic coil is coupled to an actuator, the actuator configured to adjust a position of the at least one magnetic coil.

14. The system of claim 10, wherein the at least one magnetic coil includes:
a magnetic coil positioned on a first side of the build platform; and
a distinct magnetic coil positioned on a second side of the build platform, opposite the first side of the build platform.

15. The system of claim 10, wherein the at least one magnetic coil includes:
a first magnetic coil positioned above the build platform; and
a second magnetic coil positioned below the magnetic powder material positioned on the build platform.

16. An additive manufacturing system comprising:
a build platform;
at least one magnet positioned adjacent the build platform, the at least one magnet configured to:
manipulate a magnetic powder material positioned on the build platform to form a pre-sintered component having a first geometry; and
sinter the pre-sintered component to form a sintered component having a second geometry identical to the first geometry of the pre-sintered component; and
at least one sprayer nozzle positioned adjacent the build platform, the at least one sprayer nozzle configured to coat the pre-sintered component formed from the magnetic powder material with a binder material.

17. The system of claim 10, further comprising:
a build chamber substantially surrounding the build platform, the build chamber configured to heat the pre-sintered component to aid in forming the sintered component.

18. The system of claim 10, further comprising:
a controller in electrical communication with the at least one magnet, the controller configured to adjust a strength of a magnetic field generated by the at least one magnet.
